(19) United States
(12) Patent Application Publication
(10) Pub. No.: US 2006/0037074 A1
(43) Pub. Date: Feb. 16, 2006

(54) Computer platform external communication port access authorization method and interface

(75) Inventor: Yao-Tsung Yang, Taipei (TW)

Correspondence Address: Mr. Peter F. Corless;EDWARDS & ANGELL, LLP, 101 Federal Street, Boston, MA, 02110, US

(73) Assignee: Inventec Corporation

(21) Appl. No.: 10/920,115

(22) Filed: Aug. 16, 2004

(51) Int. Cl. G06F 12/14

(52) U.S. Cl. 726/17

(57) ABSTRACT

A computer platform external communication port access authorization method and interface is proposed, which is designed for use on a computer platform that is equipped with an external communication port for the purpose of providing a user-access authorization procedure, and which is characterized by the use of a password-checking procedure to identify whether the user of a computer platform is authorized to use the external communication port on that computer platform; if YES, the external communication port is enabled; whereas if NOT, the external communication port is disabled. his feature can help enterprises or government agencies to prevent their internal confidential computer data from being illegally copied away by their employers via the external communication port.

### BACKGROUND OF THE INVENTION

1. Field of the Invention

This invention relates to information technology (IT), and more particularly, to a computer platform external communication port access authorization method and interface which is designed for use on a computer platform, such as a desktop computer, a notebook computer, a tablet computer, a network workstation, and the like, that is equipped with an external communication port, such as a USB (Universal Serial Bus) port or a FireWire port, for the purpose of providing a user-access authorization procedure that checks whether the user of the computer platform is authorized to use the external communication port for data exchange with an external device.

2. Description of Related Art

The information technology industry has developed a portable thumb-size data storage unit, such as USB (Universal Serial Bus) flash memory, USB hard disks, etc., which allow the user to conveniently transfer data from one computer platform to another. Presently, most portable thumb-size data storage units are compliant with USB ports or FireWire ports that are standard peripheral devices on computer platforms, such as desktop computers, notebook computers, tablet computers, network workstations, and so on. These portable thumb-size data storage units are characterized by plug-and-play (PnP) capability that allows instant use without the need to apply electrical power and install drivers on the computer platform. Since these thumb-size data storage units are very small in size and thus highly portable, they are becoming a very popular computer peripheral device on the PC market.

However, for many enterprises or government agencies, the use of thumb-size data storage units means that their internal confidential business data or national security related information could be easily copied away illegally via the external USB/FireWire ports, resulting in a loss to business or a threat to national security.

### SUMMARY OF THE INVENTION

It is therefore an objective of this invention to provide a computer platform external communication port access authorization method and interface for use on a computer platform equipped with an external communication port to allow enterprises or government agencies to prevent their internal confidential computer data from being illegally copied away by their employers via the external communication port.

The computer platform external communication port access authorization method and interface according to the invention is designed for use on a computer platform, such as a desktop computer, a notebook computer, a tablet computer, a network workstation, and the like, that is equipped with an external communication port, such as a USB (Universal Serial Bus) port or a FireWire port, for the purpose of providing a user-access authorization procedure that checks whether the user of the computer platform is authorized to use the communication port.

The computer platform external communication port access authorization method and interface according to the invention is characterized by the use of a password-checking procedure to identify whether the user of a computer platform is authorized to use the external communication port (USB/FireWire) on that computer platform; if YES, the external communication port is enabled for the user to use it for external data exchange with an external device such as a portable thumb-size flash memory unit; whereas if NOT, the external communication port is disabled, and in this case, the user is only allowed to use other functions and applications on the computer platform, except the external communication port for external data exchange. This feature can help enterprises or government agencies to prevent their internal confidential computer data from being illegally copied away by their employers via the external communication port.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and object-oriented component model of the computer platform external communication port access authorization interface according to the invention.

### DETAILED DESCRIPTION OF PREFERRED EMBODIMENTS

The computer platform external communication port access authorization method and interface according to the invention is disclosed in full details by way of preferred embodiments in the following with reference to the accompanying drawings.

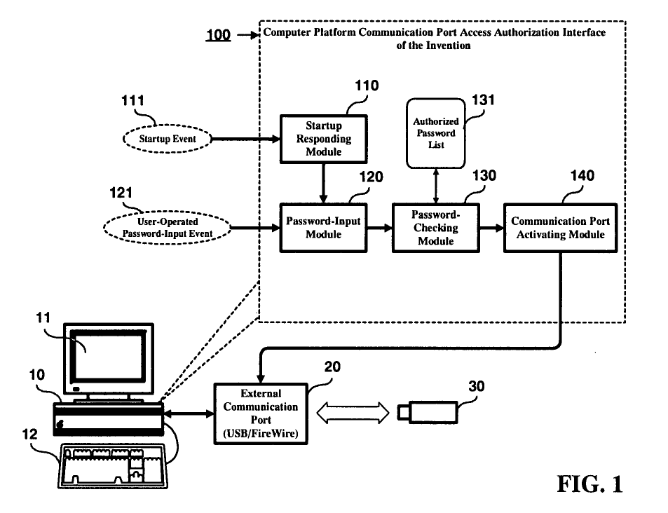

FIG. 1 is a schematic diagram showing the application architecture and object-oriented component model of the computer platform communication port access authorization interface according to the invention (as the part enclosed in the dotted box indicated by the reference numeral 100). As shown, the computer platform communication port access authorization interface of the invention 100 is designed for use with a computer platform 10, such as a desktop computer, a notebook computer, a tablet PC, a network workstation, or the like, that is equipped with an external communication port 20, such as a USB (Universal Serial Bus) port or a FireWire port, for the purpose of providing a user-access authorization procedure that checks whether the user of the computer platform 10 is authorized to use the external communication port 20. If the user is authorized to use the external communication port 20, the computer platform communication port access authorization interface of the invention 100 will switch the external communication port 20 into an enabled state to thereby allow the use to gain access to the external communication port 20 for data exchange with an external device, such as a portable thumb-size flash memory unit 30; and whereas if the user is unauthorized, the computer platform communication port access authorization interface of the invention 100 will switch the external communication port 20 to a disabled state to thereby inhibit the external communication port 20 from being accessible by the user, i.e., in this case, the user is only allowed to use other functions and applications on the computer platform 10, but not the external communication port 20 for external data exchange.

The object-oriented component model of the computer platform communication port access authorization interface of the invention 100 comprises: (a) a startup responding module 110; (b) a password-input module 120; (c) a password-checking module 130; and (d) a communication port activating module 140.

The startup responding module 110 is capable of being automatically activated when the computer platform 10 undergoes a startup procedure (i.e., a startup event 111 occurs on the computer platform 10 that includes power-on and boot) to issue a password-input enabling message to the password-input module 120.

The password-input module 120 is capable of being activated in response to the password-input enabling message from the startup responding module 110 to display a password-input interface (such as a data input window or a dialog box) on the display screen 11 of the computer platform 10 for receiving a password from the user (i.e., the user is asked to initiate a user-operated password-input event 121 to input his/her password).

The password-checking module 130 is capable of being activated in response to the completion of the password-input event 121 to compare the user-input password against a prestored list of authorized passwords 131 to check whether the user-input password is an authorized one or not. If YES, the password-checking module 130 will issue a port-enabling message to the communication port activating module 140, and whereas if NOT, the password-checking module 130 will issue a port-inhibiting message to the same. In addition, this password-checking module 130 further includes a time-out function that will issue a port-inhibiting message at the lapse of a preset time length after the password input interface has been displayed on the computer platform 10 but no password is received, i.e., if the user has failed to input a password after the password-input interface has been displayed for a preset time duration, the password-checking module 130 will also issue a port-inhibiting message.

The communication port activating module 140 is capable of activating the external communication port 20 into an enabled state in response to the port-enabling message from the password-checking module 130; whereas in the event of a port-inhibiting message being received from the password-checking module 130, the communication port activating module 140 will switch the external communication port 20 into disabled state.

In actual application, when a user wants to use the computer platform 10, the user need to first switch on the power of the computer platform 10 (thereby initiating a startup event 111 on the computer platform 10 that causes the computer platform 10 to be powered on and undergo a boot procedure). This startup event 111 will cause the startup responding module 110 to responsively issue a password-input enabling message to the password-input module 120, causing the password-input module 120 to display a password-input interface (not shown) on the display screen 11 of the computer platform 10, asking the user to input his/her password by means of the keyboard 12 of the computer platform 10. After the user has completed the inputting of his/her password (i.e., has initiated a password-input event 121), it will cause the password-checking module 130 to receive and compare the user-input password against a prestored list of authorized passwords 131 to check whether the user-input password is an authorized one or not. If YES, the password-checking module 130 issues a port-enabling message to the communication port activating module 140, and whereas if NOT, the password-checking module 130 issues a port-inhibiting message to the same. If the user has failed to input his/her password during preset time length after the password input interface has been displayed on the display screen 11 of the computer platform 10, the password-input module 120 will also issue a port-inhibiting message to the communication port activating module 140.

In response to the port-enabling message from the password-checking module 130, the communication port activating module 140 will switch the external communication port 20 to an enabled state, thereby allowing the user to use the external communication port 20 for data exchange with an external device, such as a portable thumb-size flash memory unit 30.

On the other hand, in response to the port-inhibiting message from the password-checking module 130, the communication port activating module 140 will switch the external communication port 20 to an disabled state, thus disallowing the user to use the external communication port 20 for data exchange with an external device, such as a portable thumb-size flash memory unit 30. In this case, however, the user is nonetheless allowed to use other functions and applications on the computer platform 10, other than the external communication port 20 for external data exchange.

In conclusion, the invention provides a computer platform external communication port access authorization method and interface which is designed for use on a computer platform that is equipped with an external communication port for the purpose of providing a user-access authorization procedure that checks whether the user of the computer platform is authorized to use the communication port, and which is characterized by the use of a password-checking procedure to identify whether the user of the computer platform is authorized to use the external communication port on that computer platform; if YES, the external communication port is enabled; whereas if NOT, the external communication port is disabled, and in this case, the user is only allowed to use other functions and applications on the computer platform, except the external communication port for external data exchange. This feature can help enterprises or government agencies to prevent their internal confidential computer data from being illegally copied away by their employers via the external communication port. The invention is therefore advantageous to use.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform external communication port access authorization method for use on a computer platform equipped with an external communication port, comprising:
issuing a password-input enabling message in response to a startup event on the computer platform;
in response to the password-input enabling message, displaying a password-input interface on the computer platform for receiving a password from a user-operated password-input event through the password-input interface;
comparing the user-input password received by the password-input module against a prestored list of authorized passwords to check whether the user-input password is an authorized one; if yes, issuing a port-enabling message; and if not, issuing a port-inhibiting message; and
in response to the port-enabling message from the password-checking module, activating the external communication port into an enabled state; and in response to the port-inhibiting message from the password-checking module, switching the external communication port into a disabled state.

2. The computer platform external communication port access authorization method of claim 1, wherein the computer platform is a desktop computer.

3. The computer platform external communication port access authorization method of claim 1, wherein the computer platform is a notebook computer.

4. The computer platform external communication port access authorization method of claim 1, wherein the computer platform is a tablet computer.

5. The computer platform external communication port access authorization method of claim 1, wherein the computer platform is a network workstation.

6. The computer platform external communication port access authorization method of claim 1, wherein the external communication port is a USB (Universal Serial Bus) port.

7. The computer platform external communication port access authorization method of claim 1, wherein the external communication port is a FireWire port.

8. A computer platform external communication port access authorization interface for use on a computer platform equipped with an external communication port, comprising:
a startup responding module, which is capable of being activated to issue a password-input enabling message in response to a startup event on the computer platform;
a password-input module, which is capable of being activated in response to the password-input enabling message from the startup responding module to display a password-input interface on the computer platform for receiving a password from a user-operated password-input event through the password-input interface;
a password-checking module, which is capable of comparing the user-input password received by the password-input module against a prestored list of authorized passwords to check whether the user-input password is an authorized one; and if yes, capable of issuing a port-enabling message, and if not, capable of issuing a port-inhibiting message; and
a communication port activating module, which is capable of activating the external communication port into an enabled state in response to the port-enabling message from the password-checking module, and into a disabled state in response to the port-inhibiting message from the password-checking module.

9. The computer platform external communication port access authorization interface of claim 8, wherein the computer platform is a desktop computer.

10. The computer platform external communication port access authorization interface of claim 8, wherein the computer platform is a notebook computer.

11. The computer platform external communication port access authorization interface of claim 8, wherein the computer platform is a tablet computer.

12. The computer platform external communication port access authorization interface of claim 8, wherein the computer platform is a network workstation.

13. The computer platform external communication port access authorization interface of claim 8, wherein the external communication port is an USB (Universal Serial Bus) port.

14. The computer platform external communication port access authorization interface of claim 8, wherein the external communication port is a FireWire port.

15. The computer platform external communication port access authorization interface of claim 8, wherein the password-checking module further includes a time-out function that issues a port-inhibiting message at the lapse of a preset time length after the password input interface has been displayed on the computer platform and no password is received.
